(19) United States
(12) Patent Application Publication
(10) Pub. No.: US 2025/0296272 A1
(43) Pub. Date: Sep. 25, 2025

(54) DYNAMIC MIXING DEVICE FOR A FLUID, EXTRUDER HAVING A MIXING DEVICE OF THIS KIND, AND METHOD FOR OPERATING A DYNAMIC MIXING DEVICE FOR A FLUID

(71) Applicant: BB Engineering GmbH, Remscheid (DE)

(72) Inventor: Wolfgang Imping, Remscheid (DE)

(21) Appl. No.: 19/082,839

(22) Filed: Mar. 18, 2025

(30) Foreign Application Priority Data
Mar. 19, 2024 (DE) 10 2024 000 885.3

(51) Int. Cl. B29C 48/36; B29C 48/395; B29C 48/67; B29C 48/68; B29C 48/80

(52) U.S. Cl. CPC B29C 48/363; B29C 48/397; B29C 48/67; B29C 48/681; B29C 48/80

(57) ABSTRACT

An extruder includes a mixing device having a mixing chamber formed by a housing, a stator and a rotor. The stator and the rotor are arranged at least partially within the mixing chamber. The stator is connected to the housing and/or is formed by the housing. The rotor is rotatable about an axis of rotation (D). At least one free space, into which the stator projects at least partially in the direction of the axis of rotation (D), is formed by the rotor. The stator and/or the rotor have/has at least one temperature control channel, through which a temperature control fluid can be made to flow in order to control the temperature of the stator and/or of the rotor. The extruder further includes a screw housing, a screw drive, and an extruder screw, which is mounted to the screw housing and is coupled to the screw drive.

The present invention relates to a dynamic mixing device for a fluid, to an extruder having a mixing device of this kind, and to a method for operating a dynamic mixing device for a fluid. The fluid is, in particular, in the form of a viscous medium. As a fluid it would be possible, for example, to use a melted polymer and/or a mixture thereof with fillers and/or low-viscosity solutions.

DE 10 2021 002 064 A1 shows a dynamic mixing device having a stator and a rotor arranged coaxially with the stator, wherein the rotor is mounted so as to be rotatable relative to the stator about an axis of rotation, wherein at least some section of the stator is arranged within a volume defined by the rotor. The stator and the rotor are arranged at least partially within a mixing chamber formed by means of a housing. At least one of the fluids to be mixed can be fed to the mixing chamber along the axis of rotation and through the stator, or a correspondingly mixed fluid can be discharged from the mixing chamber in the reverse direction. The temperature of the housing can be controlled from the outside by means of a temperature control system, e.g. a heating/cooling sleeve.

During operation, there is the problem here that the fluid is intensively heated by the dynamic mixing process. The external temperature control then leads to a temperature gradient within the fluid and thus also to nonuniform properties of the fluid. Particularly in the centre of the mixing chamber or with increasing distance from the temperature control system, the fluid may have an excessive temperature, at which, for example, there is a high risk of unwanted degradation of a fluid in the form of a melted polymer. Moreover, the temperature control capacity of the temperature control system is fundamentally limited overall, namely on account of the external heat transfer surfaces, which are only small.

The prior art furthermore includes a multiplicity of static mixers for fluids, in particular for viscous media such as melted polymers. EP 1 067 352 A1 shows a static mixer of this kind for heat exchange in a flow channel for flowing fluids, having at least one mixing insert with an integrated tube bundle. The mixing inserts have four web plates which pass through in a mutually intersecting manner and shortened mutually intersecting web plates.

EP 2 851 118 B1 describes a device for static mixing and for heat exchange. The device has a casing element and a mixer insert. In the operating state, the mixer insert is arranged in the interior of the casing element. The mixer insert has a longitudinal axis and comprises a first group of web elements and a second group of web elements. The first group of web elements extends along a common first group plane, and the second group of web elements extends along a second common group plane. At least some of the web elements have channels. The channels extend from a first end of the web element to a second end of the web element. Each casing element contains a corresponding channel, which is fluidically connected to the first end and the second end of the web element, wherein the transition from at least one of the first and second ends of the web element to the respectively corresponding channel in the casing element takes place without a gap.

EP 2 052 199 A1 shows an apparatus which combines heat transfer between a liquid and a heat transfer medium with static mixing of the liquid. The apparatus comprises internal fittings arranged in a casing. The casing extends longitudinally between a head end and a base end. The internal fittings form a heat-transfer and mixing structure. The heat transfer medium can be carried from the base end to the head end as an internal flow in tubes of the internal fittings.

EP 2 113 732 A1 shows a mixer/heat exchanger for heating and cooling flowable materials, having a flow channel with heat exchanger tubes and static mixing elements arranged on a longitudinal axis. The heat exchanger tubes pass through the mixing elements via openings in a manner that involves essentially form-fitting engagement. The heat exchanger tubes and the mixing elements can be moved relative to one another along the longitudinal axis to produce a scraping movement on the surface of the heat exchanger tubes. It is thereby possible to remove deposits on the heat exchanger tubes in a simple manner without disassembling the mixer/heat exchanger.

Only a small additional mixing effect, if any, can be achieved by the scraping action. However, scraping is not usually carried out during normal production so that the deposits do not get into the product to be produced. On the contrary, scraping is preferably carried out in cleaning cycles, in which no product is being produced.

The static mixers shown here have only a poor mixing effect. In order nevertheless to be able to achieve the desired necessary mixing effect, correspondingly large static mixers with an installation space requirement that is then also large are used. However, static mixing also leads to a large pressure loss, and therefore, in some cases, an additional pump is required in the installations in which the static mixer is used.

However, such an additional pump then leads in turn for its part to an unwanted increase in the temperature of the fluid and also to additional costs.

DE 2 146 150 A1 discloses a mixer having a device for cooling pulverulent, granular, liquid or other flowable mixing material, in particular agglomerates of plastics. The mixer has an optionally double-walled, pot-shaped mixing container, through which a coolant flows and which has a mixing tool which revolves in the centre above the base thereof. Projecting into the interior of the mixing container are double-walled, spade-shaped cooling elements designed as guide vanes, through which coolant flows, which are preferably concavely curved in relation to the central axis of the mixing container, said cooling elements being arranged at a distance from the inner wall of the mixing container and being arranged in series at a distance from one another in the circumferential direction and being capable of being adjusted and set relative to the inflowing mixing material in such a way that the trailing edge is radially further in than the leading edge. However, the mixer shown here has only limited suitability for mixing and cooling fluids such as melted polymers. It is primarily intended for mixing and controlling the temperature of bulk materials, e.g. plastic granules. The structure of the mixer is namely of very complex design, leading, as a fluid flows through, to a large number of dead zones, in which, for example, a fluid in the form of a melted polymer degrades. The complex structure alone already leads to a high outlay in the design and also the production of the mixer.

The object on which the invention is based is thus that of providing a dynamic mixing device for a fluid, an extruder having a mixing device of this kind, and a method for operating a dynamic mixing device for a fluid which reduce or eliminate the problems of the prior art. In particular, the intention is to enable simultaneous and effective mixing and temperature control of the fluid.

This object is achieved in the first instance by a dynamic mixing device as disclosed herein.

Further advantageous embodiments are disclosed herein.

To be more precise, the object is achieved by a dynamic mixing device for a fluid, in particular for a viscous medium, having a mixing chamber formed by means of a housing, a stator and a rotor, wherein the stator and the rotor are arranged at least partially within the mixing chamber, wherein the stator is connected to the housing and/or is formed by means of the housing, wherein the rotor is rotatable about an axis of rotation, wherein at least one free space, into which the stator projects at least partially in the direction of the axis of rotation, is formed by means of the rotor, wherein the stator and/or the rotor have/has at least one temperature control channel, through which a temperature control fluid can be made to flow, in particular by applying a pressure difference to the temperature control channel, in order to control the temperature of the stator and/or of the rotor.

At least in part and in the portion which projects into the free space of the rotor, the stator is at a shorter distance from the axis of rotation than the rotor region which forms this free space. A plane arranged perpendicularly to the axis of rotation then passes through that portion of the stator which projects into the free space of the rotor and through the rotor. This plane then advantageously also passes through the temperature control channel. Thus, the fluid can be simultaneously and effectively mixed and temperature-controlled. By means of the rotor, it is namely possible to achieve effective dynamic mixing and, by virtue of flow of the temperature control fluid through the temperature control channel of the stator and/or of the rotor, the fluid can be temperature-controlled, in particular cooled, in the regions in which the fluid is heated by the dynamic mixing process. Moreover, a large heat transfer surface area between the stator and/or the rotor and the fluid can be achieved. It should be clarified at this point that the fluid to be mixed, from which a product is to be produced, and the temperature control fluid do not mix in the mixing device, i.e. the mixing chamber and the temperature control channel are designed to be fluidically separate from one another.

Rotation of the rotor can advantageously be used to generate a fluid flow of the fluid from the rotor in the direction of the stator, and/or to modify such a fluid flow in order to mix the fluid. For this purpose, the rotor and/or the stator have/has corresponding surfaces or edge contours. For example, webs could be arranged and/or formed on the surface of the rotor. In particular, shear of the fluid between the rotor and the stator can be generated, in particular, by rotation of the rotor, wherein mixing is promoted by the shear. By means of the rotation of the rotor, it is possible to produce preferably steady or alternating dynamic exchange of the fluid between the rotor, the stator and/or an inner wall of the housing. For example, flow of the fluid from the rotor to the stator and back again can be generated. In this way, on the one hand, good mixing of the fluid is achieved and, on the other hand, good temperature control of the fluid is possible since it can be passed repeatedly to the temperature control channels.

In one preferred embodiment of the mixing device, the stator and the rotor are arranged at least partially coaxially with one another. In this way it is possible to produce small interspaces between the stator and the rotor, thereby enabling better mixing of the fluid, in particular on account of high shear forces. Moreover, uniform mixing of the fluid in the circumferential direction of the rotor can be achieved. The mixing chamber is preferably of cylindrical design. As a further preference, the mixing chamber is then also arranged coaxially with the stator and/or rotor.

In one particularly preferred embodiment of the mixing device, the rotor has at least one rotor aperture. The rotor aperture is formed, in particular, in the rotor region that forms the free space. By means of the inner walls of the rotor which are formed by the rotor aperture, the fluid can be accelerated as the rotor rotates, and in this way the fluid flow, in particular in the direction of the stator, can be generated. A multiplicity of rotor apertures is preferably distributed over the circumference of the rotor and/or in the longitudinal direction of the rotor, and therefore the described acceleration of the fluid leads to particularly good and uniform mixing of the fluid. Moreover, the rotor aperture increases the surface area of the rotor, thus enabling a greater heat transfer between the fluid and the rotor.

As a further preference, the stator has at least one stator recess and/or one stator aperture. In this way, the mixing of the fluid can be further improved, namely by deflection of the fluid at the stator recess and/or the stator aperture. There is also preferably a multiplicity of stator recesses and/or stator apertures distributed over the circumference of the stator and/or in the longitudinal direction of the stator, thus further improving the mixing of the fluid. Moreover, the stator recess and/or the stator aperture increase/increases the surface area of the stator, thus enabling a greater heat transfer between the fluid and the stator.

It may be advantageous if the rotor aperture and the stator recess and/or the stator aperture overlap at least partially at least temporarily during rotation of the rotor. In this way, the mixing of the fluid can be further improved.

The rotor advantageously has at least one sleeve of hollow-cylindrical design, wherein the sleeve is connected, in particular screwed or welded, at one of its ends to a rotor shaft. By means of the sleeve, the rotor can be produced particularly easily and with little effort. For example, an initially flat metal sheet could be bent to form the sleeve and then welded to the rotor shaft. It would then advantageously be possible to introduce the said rotor aperture into the still flat plate with little effort by means of a punching method. On the other hand, the rotor could also be formed by means of a group/a multiplicity of preferably straight, bar-shaped mixing elements which are connected together.

The rotor preferably has two or more, preferably three to six, particularly preferably four, sleeves of hollow-cylindrical design arranged coaxially with one another. In this way, the mixing of the fluid can be further improved. The heat transfer between the fluid and the rotor can also be further improved by such an enlargement of the surface area of the rotor. These sleeves are preferably all connected to the rotor shaft by ends aligned towards the same side.

According to another embodiment of the mixing device, the stator has at least one tube loop. The tube loop projects at least partially into the free space of the rotor at least partially in the direction of the axis of rotation. The tube loop can be supplied with the temperature control fluid via a feed connection preferably arranged outside the free space. The temperature control fluid can be discharged from the tube loop via a discharge connection preferably arranged outside the free space. Such a tube loop is easy to produce, e.g. by means of an appropriate bending method. The stator aperture is then formed, in particular, between two mutually opposite regions of the tube loop.

According to another advantageous embodiment of the mixing device, the stator has a plurality of tube loops, which are arranged in a rotationally symmetrical manner with respect to the axis of rotation. In particular, the tube loops are arranged to form a ring. By means of this rotationally symmetrical arrangement with respect to the axis of rotation, in combination with the rotation of the rotor about the axis of rotation, particularly uniform mixing of the fluid can be achieved.

According to another, particularly advantageous, embodiment of the mixing device, the stator has at least one group of tube loops arranged in a rotationally symmetrical manner with respect to the axis of rotation. The tube loops of the group each project at least partially into a free space of the rotor formed between two adjacent sleeves. In this way, the mixing of the fluid is further improved, in particular by multiple shearing of the fluid. In addition, the surface area of the stator is further enlarged, thus enabling greater heat transfer between the fluid and the stator.

The object on which the invention is based is also achieved by an extruder having a mixing device as disclosed herein.

To be more precise, the object is achieved when the extruder has an extruder screw, which is mounted in a screw housing of the extruder and is coupled to a screw drive of the extruder, wherein the housing of the mixing device is connected to the screw housing and/or is formed at least partially by means of the screw housing.

The dynamic mixing device ensures that the fluid, in particular the melted polymer, leaves the extruder at the desired, in particular not excessive, temperature during operation of the extruder, and furthermore that a high uniformity of the properties of the fluid is achieved by means of the good mixing. The high uniformity relates, for example, to the distribution of fillers arranged in the fluid, such as colouring particles and/or the chemical composition of the fluid. However, the high uniformity also relates to the distribution of the temperature of the fluid across the flow cross sections thereof. The dynamic mixing device can be retrofitted in a simple manner to already existing extruders. In particular, the mixing device can be connected to the rest of the extruder in place of a so-called measuring head of the extruder. Such a measuring head generally has an outlet of the extruder and at least partially surrounds a mixing region of the extruder screw, via which the fluid, in particular the melted polymer, leaves the extruder during the operation thereof. The measuring head thus forms one end of the extruder. The dynamic mixing device could similarly also be retrofitted in a simple manner to other mixers, e.g. 3DD mixers with a separate drive. However, the dynamic mixing device can also be provided right from the design stage of the extruder and/or other mixers, such as the 3DD mixers with a separate drive.

It is advantageous if the rotor, in particular the rotor shaft, is connected to the extruder screw at an end remote from the screw drive, in particular by means of a screwed connection. Assembly of the extruder is thus a simple matter.

In one preferred alternative embodiment of the extruder, the extruder screw is formed integrally with the rotor. In this way, it is advantageously possible to avoid joining between the extruder screw and the rotor.

As a further preference, the extruder screw has an internal temperature control system, via which the rotor can be supplied with temperature control fluid. At least one temperature control channel formed in the extruder screw is then fluidically connected to a temperature control channel formed in the rotor. At an opposite end of the extruder screw from the mixing device, the internal temperature control system, in particular the temperature control channel formed in the extruder screw, can be supplied via a rotary union, e.g. by means of a pump, with the temperature control fluid, which is then under pressure.

The object on which the invention is based is also achieved by a method for operating a dynamic mixing device for a fluid as disclosed herein.

To be more precise, the object is achieved when a rotor of the mixing device is rotated within a mixing chamber formed by means of a housing of the mixing device about an axis of rotation and about a stator of the mixing device, which is also arranged at least partially within the mixing chamber, is connected to the housing and/or is formed by means of the housing and projects at least partially into a free space of the rotor, wherein the stator and/or the rotor are/is temperature-controlled by means of a temperature control fluid flowing through a temperature control channel of the stator and/or of the rotor. Thus, the fluid is simultaneously and effectively mixed and temperature-controlled. The fluid flows through the mixing chamber on account of a pressure difference applied across the mixing chamber and/or on account of acceleration of the fluid by means of the rotor.

The dynamic mixing device for a fluid is employed, in particular, in combination with an extruder designed as a metering extruder, which is preferably designed for processing plastics such as PET, PA, PP, PE and/or mixtures thereof with fillers and/or low-viscosity solutions. Such metering extruders have, in particular, inside diameters of the screw housing, which is also referred to as an extruder cylinder, of 200 mm to 400 mm, preferably of 250 mm to 300 mm, in particular of 250 mm, 275 mm, 300 mm, 330 mm or 350 mm. The dynamic mixing device can also be used in combination with other mixers, e.g. the so-called 3DD mixer with a separate drive.

Preferred embodiments are explained in greater detail below with reference to the attached figures.

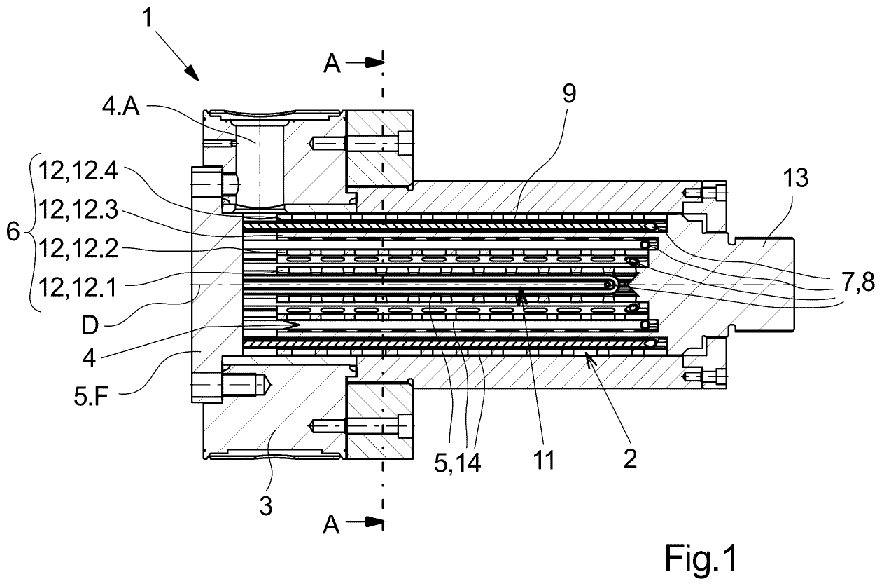

FIG. 1 schematically shows a first embodiment of the dynamic mixing device for a fluid in a side view in section.

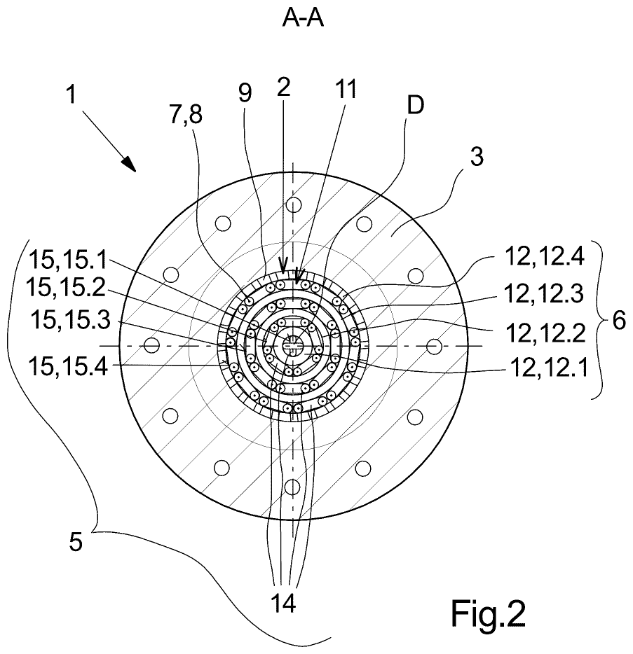

FIG. 2 schematically shows the first embodiment of the mixing device in a section along the line A-A in FIG. 1.

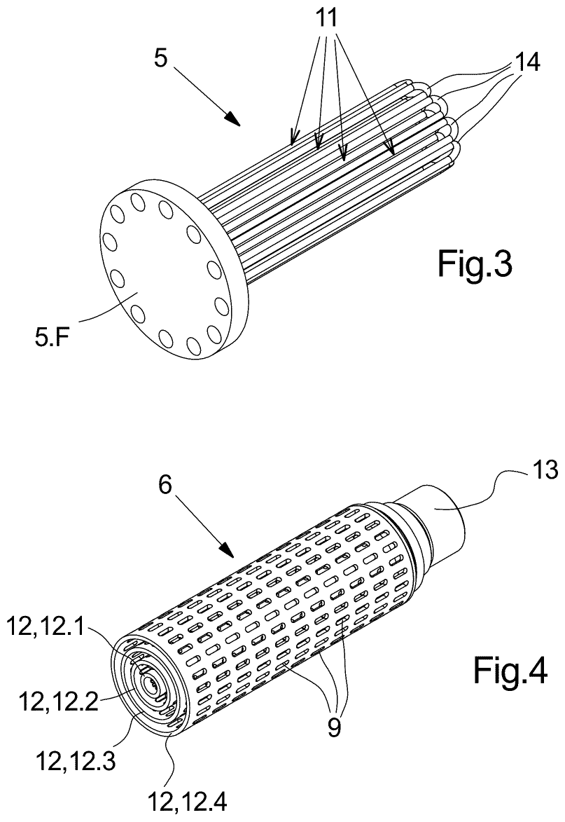

FIG. 3 schematically shows a stator of the first embodiment of the mixing device in a three-dimensional view.

FIG. 4 schematically shows a rotor of the first embodiment of the mixing device in a three-dimensional view.

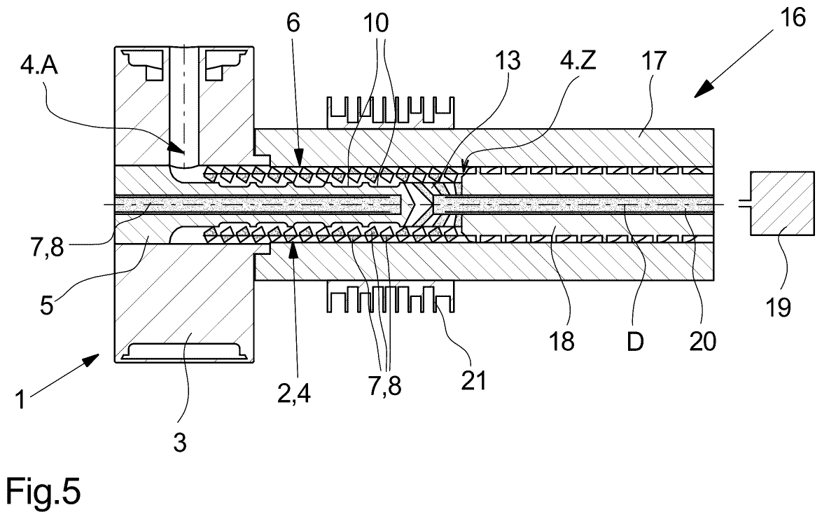

FIG. 5 schematically shows an extruder having a dynamic mixing device for a fluid in a side view in section, the said mixing device being designed in accordance with a second embodiment.

A dynamic mixing device 1 for a fluid 2, in particular for a viscous medium, as per FIG. 1, FIG. 2 and FIG. 5, has inter alia a mixing chamber 4 formed by means of a housing 3, a stator 5 and a rotor 6. The stator 5 and the rotor 6 are arranged at least partially within the mixing chamber 4. The stator 5 is connected to the housing 3 and/or formed by means of the housing 3. The rotor 6 is rotatable about an axis of rotation D. By means of the rotor 6, at least one free space is formed, into which the stator 5 at least partially projects in the direction of the axis of rotation D. The stator 5 and/or the rotor 6 have/has at least one temperature control channel 7, through which a temperature control fluid 8 can be made to flow in order to control the temperature of the stator 5 and/or of the rotor 6.

According to the first embodiment of the mixing device 1 only the stator 5 has a plurality of temperature control channels 7 in this case. According to the second embodiment of the mixing device 1 in FIG. 5, the stator 5 and the rotor 6 have temperature control channels 7. On the other hand, it would also be conceivable for only the rotor to have at least one temperature control channel.

According to FIG. 1, the housing 3 is of multi-part design, wherein the individual housing parts are connected to one another by means of respective screwed connections. The stator 5 has a flange 5.F, by means of which the stator 5 is connected to the housing 3, in particular by means of a screwed connection. From the flange 5.F, the temperature control channels 7 preferably lead substantially parallel to the axis of rotation D in the direction of the rotor 6.

Rotation of the rotor 6 can be used to generate a fluid flow of the fluid 2 from the rotor 6 in the direction of the stator 5, and/or to modify such a fluid flow in order to mix the fluid 2. By means of this fluid flow, the fluid 2 can be guided, preferably repeatedly, in the direction of the temperature control channels 7. The fluid 2 can be fed to the mixing chamber 4 via an inlet 4.Z and discharged from it via an outlet 4.A. It would also be conceivable to provide two or more inlets and/or outlets in each case.

During the operation of the mixing device 1, the fluid 2 flows through the mixing chamber 4 from the inlet 4.Z to the outlet 4.A. The fluid 2 can be fed to the inlet 4.Z under elevated pressure. On the other hand, a fluid flow of the fluid 2 from the inlet 4.Z to the outlet 4.A can also be generated, or at least assisted, by the rotation of the rotor 6. For this purpose, the rotor 6 then has a corresponding outer contour.

The stator 5 and the rotor 6 are arranged at least partially coaxially with one another. The rotor 6 surrounds at least parts of the stator 5 in the region of the free space, preferably in a ring shape. Outer and/or inner circumferences of the stator 5 and/or of the rotor 6 are each formed substantially along a cylindrical lateral surface. On the other hand, it would also be conceivable to provide differently shaped lateral surfaces.

The rotor 6 has at least one rotor aperture 9. The outer and/or inner circumferences of the rotor 6 which are each formed substantially along a cylindrical lateral surface means inter alia that these cylindrical lateral surfaces may be interrupted by such rotor apertures 9. According to FIG. 1 and FIG. 4, a multiplicity of rotor apertures 9 is provided, which are distributed uniformly in the circumferential direction and in the direction of the axis of rotation D. The rotor apertures 9 are each designed as slotted holes, the longitudinal axes of which are arranged parallel to the axis of rotation D. The longitudinal axes of the slotted holes could also be at an angle to the axis of rotation.

The stator 5 has at least one stator recess 10 and/or a stator aperture 11. The outer and/or inner circumferences of the stator 5 which are each formed substantially along a cylindrical lateral surface means inter alia that these cylindrical lateral surfaces may be interrupted by such stator recesses 10 and/or stator apertures 11. According to FIG. 5, a multiplicity of, preferably crescent-shaped, stator recesses 10 is provided, which are distributed, preferably uniformly, in the circumferential direction and in the direction of the axis of rotation D. According to FIG. 1 and FIG. 3, a multiplicity of stator apertures 11, which are formed from one end region of the stator 5 to the opposite end region of the stator 5 in the direction of the axis of rotation D, is provided, which are distributed, preferably uniformly, in the circumferential direction.

The rotor aperture 9 and the stator recess 10 and/or the stator aperture 11 overlap at least partially at least temporarily during rotation of the rotor 6. In this way, the mixing of the fluid 2 is further improved. By rotation of the rotor 6, the fluid flow of the fluid 2 can be divided into fine layers, which are continuously rearranged in various directions, in particular tangential and axial directions, and then recombined. The processes within the mixing chamber 4, which stretch, fold and move the fluid 2, combine various principles of mixing, namely dispersive mixing to break up agglomerates, e.g. fillers, distributive mixing to improve the spatial distribution of the components to be mixed, e.g. fillers and/or low-viscosity solutions, with the fluid 2, and thermal mixing to even out temperature differences within the fluid 2.

According to the first embodiment of the mixing device 1, e.g. according to FIG. 4, the rotor 6 has at least one sleeve 12 of hollow-cylindrical design. At one of its ends, the sleeve 12 is connected, in particular screwed or welded, to a rotor shaft 13. Via the rotor shaft 13, the rotor 6 can be driven by means of a rotor drive (not shown here), which is preferably formed by means of an electric motor.

The rotor 6 has two or more, preferably three to six, particularly preferably four, sleeves 12, namely a first sleeve 12.1, a second sleeve 12.2, a third sleeve 12.3 and a fourth sleeve 12.4, of hollow-cylindrical design arranged coaxially with one another. The sleeves 12.1-12.4 end at the projecting end in a common plane aligned perpendicularly to the axis of rotation D. The sleeves 12.1-12.4 have different lengths, wherein the lengths increase from the inner, first sleeve 12.1 to the outer, fourth sleeve 12.4. For this reason, the rotor shaft 13 has a stepped shape at the end closest to the sleeves 12.1-12.4, wherein a region of the rotor shaft 13 which is on the inside with respect to the axis of rotation D ends closer to the projecting end of the sleeves 12.1-12.4 than a region of the rotor shaft 13 on the outside with respect to the axis of rotation D.

As shown, for example, in FIG. 1 and FIG. 3, the stator 5 has at least one tube loop 14. The tube loop 14 projects at least partially into the free space of the rotor 6 at least partially in the direction of the axis of rotation D. In particular, the tube loop 14 is held in position by means of the flange 5.F. The tube loop 14 has a forward portion, via which the temperature control fluid 8 can be supplied from the flange 5.F in the direction of the rotor shaft 13, preferably parallel to the axis of rotation D. The tube loop 14 furthermore has a return portion, via which the temperature control fluid 8 can be returned in the direction of the flange 5.F, preferably parallel to the axis of rotation D. A deflection is formed between the forward portion and the return portion. The tube forming the tube loop 14 is preferably straight in the region of the forward portion and/or of the return portion and curved in the region of the deflection. The forward portion is used to form an inlet connection of the tube loop 14 in the region of the flange 5.F. The return portion is used to form an outlet connection of the tube loop 14 in the region of the flange 5.F. By means of a pump, for example, it is possible to generate a pressure difference in the temperature control fluid 8 between the inlet connection and the outlet connection, as a result of which difference the temperature control fluid 8 then flows through the temperature control channel 7 formed by means of the tube loop 14 during the operation of the pump.

The stator 5 has a plurality of tube loops 14, which are arranged in a rotationally symmetrical manner with respect to the axis of rotation D. The tube loops 14 are arranged in a substantially rotationally symmetrical manner with respect to the axis of rotation D and also in a nested relationship to one another, for example, as shown in FIG. 1 and FIG. 2 for the two tube loops 14 arranged closest to the axis of rotation D. As is shown for the other tube loops 14 in FIG. 1 and FIG. 2, these are also arranged in a manner substantially rotationally symmetrical with respect to the axis of rotation D and furthermore in such a way as to form at least one ring.

The stator 5 has at least one group 15 of tube loops 14 arranged in a rotationally symmetrical manner with respect to the axis of rotation D. According to FIG. 2, four groups 15, namely a first group 15.1 of tube loops 14, a second group 15.2 of tube loops 14, a third group 15.3 of tube loops 14, and a fourth group 15.4 of tube loops 14, are provided. The tube loops 14 of the group 15.2, 15.3, 15.4 each project at least partially into a free space of the rotor 6 formed between two adjacent sleeves 12.1-12.4. The two tube loops 14 arranged closest to the axis of rotation D form the first group 15.1 and each project at least partially into the first sleeve 12.1. The second group 15.2 is formed by five tube loops 14 of identical construction arranged to form a ring, which project at least partially into the interspace between the first sleeve 12.1 and the second sleeve 12.2. The third group 15.3 is formed by eight tube loops 14 of identical construction arranged to form a ring, which project at least partially into the interspace between the second sleeve 12.2 and the third sleeve 12.3. The fourth group 15.4 is formed by eleven tube loops 14 of identical construction arranged to form a ring, which project at least partially into the interspace between the third sleeve 12.3 and the fourth sleeve 12.4. On the other hand, it would also be possible to provide a different number of tube loops per group. Moreover, it would also be possible to arrange other parts of the stator, in particular corresponding tube loops, outside the outer, fourth sleeve.

The inlet connections of a plurality, preferably all, of the tube loops 14 are preferably connected jointly to an outlet of a pump. The outlet connections of a plurality, preferably all, of the tube loops 14 are preferably connected jointly to an inlet of a pump.

According to FIG. 5, the stator 5 has a recess in the direction of the axis of rotation D, in which a tube is arranged. Via the interior of the tube, the temperature control fluid 8 can be carried in the direction of the rotor shaft 13. The temperature control fluid 8 can be carried back in a direction away from the rotor shaft 13 on the outer circumference of the tube. Opposite flows through and around this tube would also be conceivable.

The mixing chamber 4 is embodied as a cylinder. A ratio between a length of the mixing chamber and an inside diameter of the mixing chamber 4 has values of two to five, preferably approximately three.

FIG. 5 shows an extruder 16 having a mixing device 1 according to a second embodiment and having an extruder screw 18, which is mounted in a screw housing 17 of the extruder 16 and is coupled to a screw drive 19 of the extruder 16. The housing 3 of the mixing device 1 is connected to the screw housing 17 and/or formed at least partially by means of the screw housing 17. Here, the inlet 4.Z of the mixing chamber 4 is formed in the region of an end of the extruder screw 18 adjacent to the mixing device 1, at which end the extruder screw 18 is connected to the rotor 6. The inlet 4.Z is of annular design, namely between an inside diameter of the screw housing 17 and a core diameter of the extruder screw 18. At the opposite end of the rotor 6 from the extruder screw 18, the outlet 4.A of the mixing chamber 4 is designed as a passage in the housing 3 aligned radially with respect to the axis of rotation D.

The rotor, in particular the rotor shaft, could be connected to the extruder screw at an end remote from the screw drive, in particular by means of a screwed connection. In particular, the first embodiment of the mixing device, which is shown in FIG. 1, could be used for this purpose and, for this purpose, then has an external thread on the rotor shaft 13. According to FIG. 5, the extruder screw 18 is formed integrally with the rotor 6. Other connection mechanisms between the rotor, in particular the rotor shaft, and the extruder screw are conceivable.

The extruder screw 18 has an internal temperature control system 20, via which the rotor 6 can be supplied with temperature control fluid 8. According to FIG. 5, the extruder screw 18, like the stator 5, has for this purpose a recess in the direction of the axis of rotation D, in which a tube is arranged. Via the interior of the tube, the temperature control fluid 8 can be carried to the rotor shaft 13. Via temperature control channels 7 formed in the rotor 6, the temperature control fluid 8 can be directed around the stator 5 and in the direction of the axis of rotation D as far as an opposite end region of the mixing chamber 4 from the extruder screw 18, and back again. The temperature control fluid 8 can then be carried back in the direction of the screw drive 19 in a direction away from the rotor shaft 13 on the outer circumference of the tube. Opposite flows through and around the tube would also be conceivable. The temperature control fluid 8 can usually be fed to the extruder screw 18, in particular to the internal temperature control system 20 thereof, via what is known as a rotary union in the region of the screw drive 19. The temperature control fluid 8 used for the internal temperature control system 20 is preferably the same temperature control fluid 8 as that for the flow through the stator 5, and therefore the stator 5, the rotor 6 and the internal temperature control system 20 are part of a common temperature control circuit, for the flow through which preferably only one pump is then necessary. FIG. 5 shows another temperature control system 21 of the extruder 16, which is here embodied as a heating/cooling sleeve arranged around the outer circumference of the screw housing 17. The temperature control system 21 preferably has an electric heating system and an air cooling system, wherein the air cooling system can be formed inter alia by means of cooling fins and preferably by means of a fan.

A method for operating a dynamic mixing device 1 for a fluid 2, e.g. according to its first or second embodiment, is now described below. Here, the dynamic mixing device 1 can also be part of the extruder 16. The rotor 6 of the mixing device 1 is rotated within the mixing chamber 4 formed by means of the housing 3 of the mixing device 1 about the axis of rotation D and about a stator 5 of the mixing device 1, which is also arranged at least partially within the mixing chamber 4, is connected to the housing 3 and/or is formed by means of the housing 3 and projects at least partially into a free space of the rotor 6. The stator 5 and/or the rotor 6 are/is temperature-controlled by means of a temperature control fluid 8, which flows through a temperature control channel 7 of the stator 5 and/or of the rotor 6.

Owing to the rotation of the rotor 6, the fluid 2 is mixed particularly well and, at the same time, temperature-controlled, and therefore the fluid 2 leaving the mixing device 1 has particularly uniform properties. In further method steps, particularly high-value products, e.g. fibres, threads and/or films, can therefore be produced from the fluid 2.

### LIST OF REFERENCE SIGNS

1 dynamic mixing device
2 fluid
3 housing
4 mixing chamber
4.Z inlet of the mixing chamber 4
4.A outlet of the mixing chamber 4
5 stator
5.F flange
6 rotor
7 temperature control channel
8 temperature control fluid
9 rotor aperture
10 stator recess
11 stator aperture
12 sleeve
12.1 first sleeve
12.2 second sleeve
12.3 third sleeve
12.4 fourth sleeve
13 rotor shaft
14 tube loop
15 group of tube loops 14
15.1 first group of tube loops 14
15.2 second group of tube loops 14
15.3 third group of tube loops 14
15.4 fourth group of tube loops 14
16 extruder
17 screw housing
18 extruder screw
19 screw drive
20 internal temperature control system
21 temperature control system
D axis of rotation

1. Dynamic mixing device for a fluid, comprising:
a mixing chamber formed by a housing, a stator and a rotor, wherein the stator and the rotor are arranged at least partially within the mixing chamber, wherein the stator is connected to the housing and/or is formed the housing, wherein the rotor is rotatable about an axis of rotation (D), wherein at least one free space, into which the stator projects at least partially in the direction of the axis of rotation (D), is formed by means of the rotor, wherein the stator and/or the rotor have/has at least one temperature control channel, through which a temperature control fluid can be made to flow in order to control the temperature of the stator and/or of the rotor.

2. Mixing device according to claim 1, wherein rotation of the rotor can be used to generate a fluid flow of the fluid from the rotor in the direction of the stator, and/or to modify such a fluid flow in order to mix the fluid.

3. Mixing device according to claim 1, wherein the stator and the rotor are arranged at least partially coaxially with one another.

4. Mixing device according to claim 1, wherein the rotor has at least one rotor aperture.

5. Mixing device according to claim 4, wherein the stator has at least one stator recess and/or one stator aperture.

6. Mixing device according to claim 5, wherein the rotor aperture and the stator recess and/or the stator aperture overlap at least partially at least temporarily during rotation of the rotor.

7. Mixing device according to claim 1, wherein the rotor has at least one sleeve of hollow-cylindrical design, wherein the sleeve is connected, in particular screwed or welded, at one of its ends to a rotor shaft.

8. Mixing device according to claim 1, wherein the rotor has multiple sleeves of hollow-cylindrical design arranged coaxially with one another.

9. Mixing device according to claim 1, wherein the stator has at least one tube loop, wherein the tube loop projects at least partially into the free space of the rotor at least partially in the direction of the axis of rotation (D).

10. Mixing device according to claim 1, wherein the stator has a plurality of tube loops, which are arranged in a rotationally symmetrical manner with respect to the axis of rotation (D).

11. Mixing device according to claim 10, wherein the stator has at least one group of tube loops arranged in a rotationally symmetrical manner with respect to the axis of rotation (D), wherein the tube loops of the group each project at least partially into a free space of the rotor formed between two adjacent sleeves.

12. Extruder, comprising:
a mixing device having a mixing chamber formed by a housing, a stator and a rotor, wherein the stator and the rotor are arranged at least partially within the mixing chamber, wherein the stator is connected to the housing and/or is formed by the housing, wherein the rotor is rotatable about an axis of rotation (D), wherein at least one free space, into which the stator projects at least partially in the direction of the axis of rotation (D), is formed by the rotor, wherein the stator and/or the rotor have/has at least one temperature control channel, through which a temperature control fluid can be made to flow in order to control the temperature of the stator and/or of the rotor,
a screw housing,
a screw drive, and
an extruder screw, which is mounted to the screw housing and is coupled to the screw drive, wherein the housing of the mixing device is connected to the screw housing and/or is formed at least partially by the screw housing.

13. Extruder according to claim 12, wherein the rotor, in particular the rotor shaft, is connected to the extruder screw at an end remote from the screw drive, in particular by a screwed connection.

14. Extruder according to claim 12, wherein the extruder screw is formed integrally with the rotor.

15. Extruder according to claim 12, wherein the extruder screw has an internal temperature control system, via which the rotor can be supplied with temperature control fluid.

16. Method for operating a dynamic mixing device for a fluid and/or for operating an extruder having the dynamic mixing device, wherein a rotor of the mixing device is rotated within a mixing chamber formed by a housing of the mixing device about an axis of rotation (D) and about a stator of the mixing device, which is also arranged at least partially within the mixing chamber, is connected to the housing and/or is formed by the housing and projects at least partially into a free space of the rotor, wherein the stator and/or the rotor are/is temperature-controlled by a temperature control fluid flowing through a temperature control channel of the stator and/or of the rotor.
